(19) United States
(12) Patent Application Publication
(10) Pub. No.: US 2015/0018069 A1
(43) Pub. Date: Jan. 15, 2015

(54) GAMING MACHINE & METHOD FOR TRIGGERING A BONUS EVENT

(71) Applicant: Atlas Gaming Technologies Pty. Ltd., Port Melbourne (AU)

(72) Inventors: DANIEL JULIO MONTENEGRO, Port Melbourne (AU); ZENJA SOLAJA, Port Melbourne (AU); ROBERT SLOOT, Port Melbourne (AU); ALESSANDRO CIAMPOLI, Port Melbourne (AU); BORIS MITLEMAN, Port Melbourne (AU); WADE CLARK, Port Melbourne (AU)

(73) Assignee: Atlas Gaming Technologies Pty. Ltd., Port Melbourne (AU)

(21) Appl. No.: 14/256,760

(22) Filed: Apr. 18, 2014

(30) Foreign Application Priority Data
Apr. 29, 2013 (AU) 2013901484

(51) Int. Cl. G07F 17/32; G07F 17/34

(52) U.S. Cl. CPC G07F 17/3213; G07F 17/34
USPC 463/20

(57) ABSTRACT

Embodiments relate generally to gaming machines, gaming systems and methods of operating such gaming machines and systems. An example gaming machine comprises: a display to display images; a user interface to receive input in relation to a player wager; a memory for storing data concerning a predetermined number of bonus symbols, a predetermined number of gaming symbols, and an association between each bonus symbol and at least one particular type of a plurality of gaming symbols; and a game controller configured, in response to the player wager, to play a primary game of chance to reveal a plurality of said gaming symbols on the display means. The game controller is further configured to: visually depict the bonus symbol with its associated gaming symbol in the revealed plurality of said gaming symbols; and determine if a configuration formed by the bonus symbols on the display screen is indicative of a trigger event, said trigger event inclusive of an opportunity to win a progressive jackpot; wherein the predetermined number of bonus symbols and the predetermined number of gaming symbols remains constant irrespective of a change in the player wager.

### TECHNICAL FIELD

Described embodiments relate generally to gaming machines and methods of controlling such machines. Particular embodiments relate to a gaming machine and method for triggering a bonus event.

### BACKGROUND

Gaming machines with bonus events are popular especially when such bonus events are easy to identify. Awarding bonuses is now a common occurrence in a majority of gaming machines. Because it is desirable for gaming machine operators, and in fact mandatory in some jurisdictions, to have an average return to player (RTP) which is independent from the player's play line selections and bet selections, one key element of the bonus award is to equalize the RTP across all possible wager events.

Many gaming machines award credit prizes, that are linear to the wager. For example, if a player bets five credits per line, and gets a combination of symbols with a pay-table prize of 100 credits, then 500 credits are awarded to the player. If the denomination of the particular gaming machine is 5 cents, 500 credits equals $2.50.

Another type of prize awarded by gaming machines is known as a jackpot progressive prize. Jackpot progressive prizes are usually awarded in dollars and cents, and they are not multiplied by credits bet per line. In order to equalize the RTP among different wagers, it is necessary that the gaming machine's controller adjusts the frequency of jackpot wins to be proportional to the bet. This can either be hidden from the player or visible to the player by increasing the number of jackpot symbols on the screen as the bet increases.

Hiding the trigger mechanism makes it difficult for the player to understand when and how they trigger the jackpot feature. Varying number of the jackpot symbols on the reels creates anticipation of the trigger, but compromises perceived integrity of the gaming machine, as it becomes obvious to the player that they are not playing the same reels at different bets.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY

Some embodiments relate to a gaming machine comprising:

a display means to display images;

a user interface to receive input in relation to a player wager;

a memory for storing data concerning a predetermined number of bonus symbols, a predetermined number of gaming symbols, and an association between each bonus symbol and at least one particular type of a plurality of gaming symbols; and

a game controller configured, in response to the player wager, to play a primary game of chance to reveal a plurality of said gaming symbols on the display means, the game controller further configured to:
visually depict the bonus symbol with its associated gaming symbol in the revealed plurality of said gaming symbols; and
determine if a configuration formed by the bonus symbols on the display screen is indicative of a trigger event, said trigger event inclusive of an opportunity to win a progressive jackpot;
wherein the predetermined number of bonus symbols and the predetermined number of gaming symbols remains constant irrespective of a change in the player wager.

In one embodiment the primary game of chance is a reel game comprising a plurality of reels and there are a predetermined number of bonus symbols and gaming symbols allocated to each reel.

The player wager associated with the primary game of chance may comprise a number of play lines and a bet per play line. Optionally, the player wager associated with the primary game of chance may comprise a number reel patterns per credit and a multiplier.

One configuration formed by the bonus symbols that is indicative of a trigger event is for a plurality of bonus symbols to align with gaming symbols associated with one of the play lines. Another configuration formed by the bonus symbols that is indicative of a trigger event is for a plurality of bonus symbols to follow the same winning pattern as the underling game symbol. For example if five Kings in a particular configuration would result in a predefined winning event occurring, then five bonus symbols in the same configuration will initiate the trigger event.

In one embodiment each bonus symbol is associated with every “King” gaming symbol and every “Ace” gaming symbol. In another embodiment, the bonus symbol may be associated with all of the selected royals of the spinning reel game. Optionally a bonus symbol may be associated with each respective Ace and each respective Queen. Other permutations are possible.

If the determination of the configuration formed from the bonus symbols is indicative of a trigger event, the game controller may be further configured to link each bonus symbol to a bonus feature selected from a set of bonus features. The set of bonus features may include any one or more of, but not be limited to, bonus prizes, multipliers and jackpot awards.

In one embodiment, the number of jackpot awards allocated to be linked to respective bonus symbols is proportional to the bet per play line. In a further embodiment the number of jackpot awards allocated to be linked to respective bonus symbols is proportional to the bet multiplier.

The game controller may be further configured to receive a player selected bonus symbol. In response, the gaming controller may be configured to display the bonus feature to which the player selected bonus symbol is linked or display each bonus feature linked to each respective bonus symbol.

Upon a player selection, the game controller may be further configured to display the bonus feature associated with each bonus symbol.

The game controller may be further configured to superimpose each bonus symbol over the underlying symbol to which it is associated. The bonus symbol may be at least partially transparent so that the underlying symbol is visible beneath it.

The game controller may be further configured to provide the spinning reel game so that each and every bonus symbol is configured to be simultaneously displayed as held with their associated underlying symbol while their respective spinning reels are spun in the play of the primary game.

The game controller may be further configured to visually enhance the depiction of each of the bonus symbols.

Some embodiments relate to a gaming system comprising at least one gaming machine as described above and at least one server system in communication with the game controller of the at least one gaming machine.

Some embodiments relate to a method of game play having a computerised game controller, the method comprising:

storing data concerning a predetermined number of bonus symbols, a predetermined number of gaming symbols, and an association between each bonus symbol and at least one particular type of a plurality of gaming symbols;

in response to the player wager, playing a primary game of chance to reveal a plurality of said gaming symbols on the display means;

visually depicting the bonus symbol with its associated gaming symbol in the revealed plurality of said gaming symbols; and

determining if a configuration formed by the bonus symbols on the display screen is indicative of a trigger event, said trigger event inclusive of an opportunity to win a progressive jackpot;
wherein the predetermined number of bonus symbols and the predetermined number of gaming symbols remains constant irrespective of a change in the player wager.

The method may involve determining if the configuration formed from the bonus symbols is indicative of a trigger event, and if the configuration is indicative of a bonus event, link each bonus symbol to a bonus feature selected from a set of bonus features.

In an embodiment of the method, the set of bonus features may include at least one of bonus prizes, multipliers and jackpot awards.

The method may involve the processor of the game controller receiving a player selected bonus symbol and in response, displaying the bonus feature to which the player selected bonus symbol is linked or displaying each bonus feature linked to each respective bonus symbol. The method may involve the processor of the game controller receiving a player selection, and displaying the bonus feature associated with each bonus symbol.

The method may involve the processor of the game controller superimposing each bonus symbol over the underlying symbol to which it is associated; where the bonus symbol is at least partially transparent so that the underlying symbol is visible beneath it.

The method may involve the processor of the game controller providing the spinning reel game so that each and every bonus symbol is configured to be simultaneously displayed as held with their associated underlying symbol while their respective spinning reels are spun in the play of the primary game.

The method may involve the processor of the game controller visually enhancing the depiction of each of the bonus symbols.

Some embodiments relate to computer-readable storage storing executable program code that, when executed by a game controller, causes the game controller to perform the methods described above and/or implement the features and functions of the game machine or game system described above.

Some embodiments relate to a computer-readable medium, the computer-readable medium storing machine-readable instructions to cause a processor of a gaming machine to:

store data concerning a predetermined number of bonus symbols, a predetermined number of gaming symbols, and an association between each bonus symbol and at least one particular type of a plurality of gaming symbols;

in response to the player wager, play a primary game of chance to reveal a plurality of said gaming symbols on the display means;

visually depict the bonus symbol with its associated gaming symbol in the revealed plurality of said gaming symbols; and

determine if a configuration formed by the bonus symbols on the display screen is indicative of a trigger event, said trigger event inclusive of an opportunity to win a progressive jackpot;

wherein the predetermined number of bonus symbols and the predetermined number of gaming symbols remains constant irrespective of a change in the player wager.

In embodiments, the primary game of chance may be a reel game comprising a plurality of reels. The medium storing machine-readable instructions may cause a processor of a gaming machine to allocate to each reel a predetermined number of bonus symbols and a predetermined number of gaming symbols.

The medium storing machine-readable instructions may cause a processor of a gaming machine to determine if the configuration formed from the bonus symbols is indicative of a trigger event, and if the configuration is indicative of a bonus event, link each bonus symbol to a bonus feature selected from a set of bonus features. In embodiments the set of bonus features may include at least one of bonus prizes, multipliers and jackpot awards.

The medium storing machine-readable instructions may cause a processor of a gaming machine to receive a player selected bonus symbol and in response, to display the bonus feature to which the player selected bonus symbol is linked or display each bonus feature linked to each respective bonus symbol.

The medium storing machine-readable instructions may cause a processor of a gaming machine to, upon a player selection, display the bonus feature associated with each bonus symbol.

The medium storing machine-readable instructions may cause a processor of a gaming machine to superimpose each bonus symbol over the underlying symbol to which it is associated; wherein the bonus symbol is at least partially transparent so that the underlying symbol is visible beneath it.

The medium storing machine-readable instructions may cause a processor of a gaming machine to provide the spinning reel game so that each and every bonus symbol is configured to be simultaneously displayed as held with their associated underlying symbol while their respective spinning reels are spun in the play of the primary game.

The medium storing machine-readable instructions may cause a processor of a gaming machine to visually enhance the depiction of each of the bonus symbols.

Some embodiments relate to agaming system comprising at least one server and at least one client device, wherein the at least one server and at least one client device are configured to cooperate with each other to execute program instructions to:

store data concerning a predetermined number of bonus symbols, a predetermined number of gaming symbols, and an association between each bonus symbol and at least one particular type of a plurality of gaming symbols;

in response to the player wager, play a primary game of chance to reveal a plurality of said gaming symbols on the display means;

visually depict the bonus symbol with its associated gaming symbol in the revealed plurality of said gaming symbols; and

determine if a configuration formed by the bonus symbols on the display screen is indicative of a trigger event, said trigger event inclusive of an opportunity to win a progressive jackpot;

wherein the predetermined number of bonus symbols and the predetermined number of gaming symbols remains constant irrespective of a change in the player wager.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF DRAWINGS

In order that the present invention may be more clearly ascertained, embodiments will now be described, by way of example, with reference to the accompanying drawing, in which:

FIG. 1 shows a perspective view of a gaming machine;

FIG. 2 shows a block diagram of a game logic circuit of the gaming machine illustrated in FIG. 1;

FIG. 3 shows a block diagram of functional components of a gaming system incorporating gaming machines illustrated in FIG. 1;

FIG. 4 is an example gaming machine display illustrating display of a plurality of mystery bonus symbols prompting initiation of the generation of a trigger event;

FIG. 5 is an example gaming machine display illustrating visual enhancement of the bonus symbols shown in FIG. 4; and

FIG. 6 is an example gaming machine display illustrating revealed bonus features associated with each of the bonus symbols shown in FIG. 5.

### DESCRIPTION OF EMBODIMENTS

Described embodiments generally relate to gaming machines and methods of controlling such machines. Particular embodiments relate to a gaming machine and method for triggering a bonus event.

The gaming system can take a number of different forms. In a first form, a stand-alone gaming machine is provided wherein all or most components required for implementing the game are present in a player operable gaming machine.

In a second form, a distributed architecture is provided wherein some of the components required for implementing the game are present in a player operable gaming machine and some of the components required for implementing the game are located remotely relative to the gaming machine. For example, a “thick client” architecture may be used wherein part of the game is executed on a player operable gaming machine and part of the game is executed remotely, such as by a gaming server; or a “thin client” architecture may be used wherein most of the game is executed remotely such as by a gaming server and a player operable gaming machine is used only to display audible and/or visible gaming information to the player and receive gaming inputs from the player.

However, it will be understood that other arrangements are envisaged. For example, an architecture may be provided wherein a gaming machine is networked to a gaming server and the respective functions of the gaming machine and the gaming server are selectively modifiable. For example, the gaming system may operate in standalone gaming machine mode, “thick client” mode or “thin client” mode depending on the game being played, operating conditions, and so on. Other variations will be apparent to persons skilled in the art.

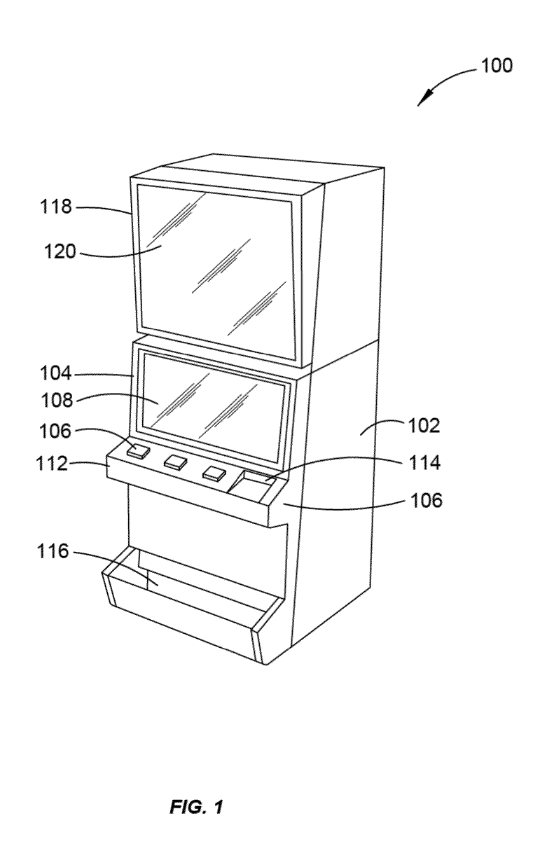

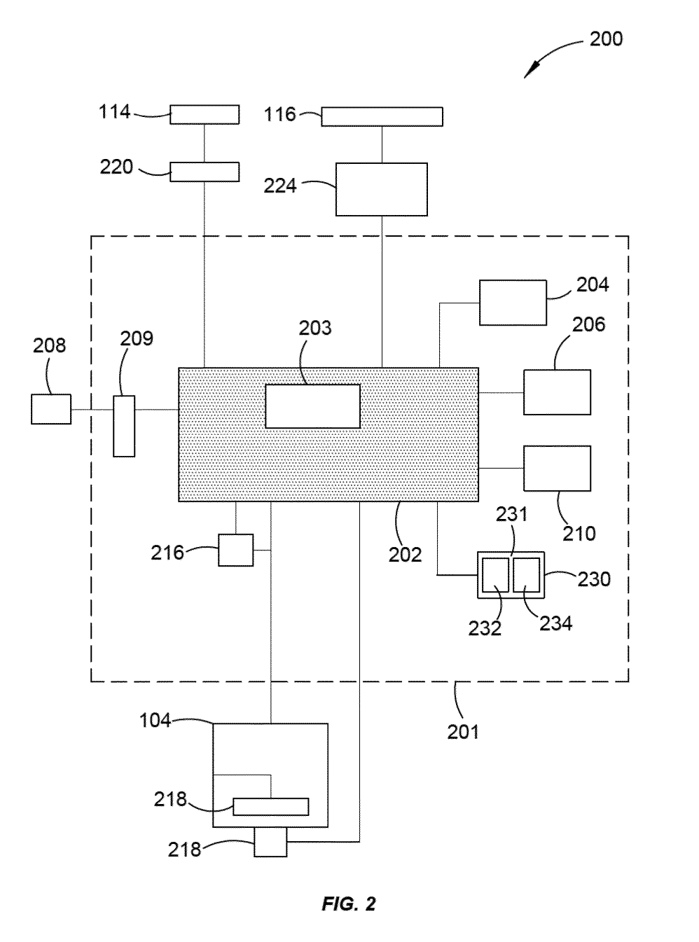

In another form, the gaming system may comprise a gaming server (or multiple gaming servers) interacting with client computing devices over a wired and/or wireless network to allow performance of the games on the client devices. Such client devices may include desktop computers, tablet computers, laptop computer and handheld computing devices (including smart phones), for example, each of which includes at least one processor and memory to store executable instructions for performing the game-related functions described herein. Such systems may therefore not require specific dedicated physical gaming machines as described herein in relation to FIGS. 1 and 2, since the client devices can in such systems perform some of the gaming functions as described herein. In such gaming systems, the client devices may locally execute gaming applications that communicate with the gaming server and, in combination with the gaming server, provide a user interface and gaming experience generally similar to that of a physical gaming machine. Thus, embodiments described herein in relation to gaming machines may be implemented “on-line” using such a client-server architecture, unless such implementations would not be physically or technologically feasible. Additionally, some embodiments described herein in relation to gaming machines may be implemented in a personal computing device without requiring interaction with a server, in which case such computing devices can be termed “gaming machines”.

One or more of the method steps described in this disclosure may be implemented by executable instructions and parameters 232, 234 (See FIG. 2), stored in the memory 204, 206, 230 (See FIG. 2), that may form software embodiments of the system 100. These instructions 232, 234 that form the system 100 may be executed by the CPU 202 (See FIG. 2) or any other processor. Further, the processor 202, the memory 204, 206, 230, the instructions 232, 234 stored therein, or a combination thereof may serve as a means for performing one or more of the method steps described herein.

Irrespective of the form, the gaming system 100 has several core components. At the broadest level, the core components are a player interface in the form of a touch screen 108 as illustrated in FIG. 1 and a game controller 200 as illustrated in FIG. 2. The player interface is arranged to enable manual interaction between a player and the gaming system and for this purpose includes the input/output components required for the player to enter instructions and play the game.

Referring now to FIG. 1, reference numeral 100 generally designates a stand-alone gaming system including a game. Hereinafter, the stand-alone gaming system 100 will be referred to as a gaming machine.

The gaming machine 100 includes a console 102 which contains all or most components required to implement a game play whereby a player wins or loses a wager. Access to the components is by way of a hinged door 105. Moulded to the exterior of the console 102 is a display means in the form of at least one visual display unit 104 on which one or more games is played. The video display unit 104 may be implemented as a liquid crystal display, a plasma screen, as a cathode ray screen device or the like. Whilst the console 102 illustrated in FIG. 1 shows a single visual display unit 104, there can be more than one visual display unit on a typical machine. What is displayed on the visual display unit 104 will depend on what the intended goal of the unit is in relation to the player and any other potential participants in the gaming system.

The gaming machine includes a tactile input for a player to interact via touch with the gaming machine 100. In this example, the tactile input is in the form of a combination of pushbuttons 106 and a touch screen 108 for enabling a player to play one or more games. The touch screen is an electronic visual display that can detect the presence and location of a touch within the display area. The touch screen 108 is used during the game play between start of a game and the end of a game. A game is considered to have started once a wager is placed and considered complete once the wager has been lost or won. Certain functions of the pushbutton are: initiation of game play, credit output, gameplay selection, completion of gameplay etc. A midtrim 112 of the machine 100 houses the pushbuttons 106.

The tactile input may optionally or further include a joystick comprising of a stick that pivots on a base and reports its angle or direction to the device it is controlling. The tactile input may optionally or further include a trackpad/touchpad being a pointing device featuring a tactile sensor to translate the motion and position of a user's fingers to a relative position on screen.

It should be appreciated that tactile input may include any suitable device that enables the player to produce an input signal that is received by the processor. Tactile input in the form of pushbuttons 106 and/or regions on touch screen 108 may include a one bet button, a max bet button, or a repeat the bet button. With a one bet button for instance, the player places a bet by pushing the one bet button. The player may increase the bet by one credit each time the player pushes the bet one button.

The midtrim 112 also houses credit input device including a bill collector 114. The credit input device may further include a coin input chute, a card and/or ticket reader, a magnetic reading head for reading a magnetic stripe card, an electronic reader for a proximity card, a near field communications reader or any other form of electronic, wireless or contact that can input credit to the gaming machine.

A credit dispenser in the form of a coin tray 116 is mounted beneath the console 102 and is provided for cash payouts from the machine 100 to the player. A hopper device (not shown) is provided which dispenses coins, or tokens equal to the amount of credit currently on the machine, into the coin tray 116. Aside from the coin tray 116, the credit dispenser may also include a ticket dispenser for issuing a ticket dispensed by a printer which the user can redeem for cash, a note dispenser, a near field communications transmitter or means to enable remote credit transfer. It should be appreciated that any suitable payout mechanisms, such as funding to the player's electronically recordable identification card or smart card, may be implemented in accordance with the gaming machine disclosed herein.

The gaming machine 100 includes a top box 118 on which artwork 120 is carried in the form of electronic visual display units. The artwork 120 could also be made from physical materials such as paper, plastic banners or posters. The artwork 120 may have generic information related to the machine or gaming system or the artwork 120 be specifically made for a particular game to be played on the machine 100. Whilst the artwork 120 is shown as being carried on the top box 118 the art work 120 can also be positioned in or on the bottom panel of the door 105, or any other part of the gaming machine 100 visible to the player.

The gaming machine 100 further includes an auditory unit in the form of speakers (not shown) to provide auditory feedback to the player of the gaming machine 100.

Referring to FIG. 2 of the drawings, game logic circuitry 200 is illustrated. The game logic circuitry 200 includes a gaming controller 201 (otherwise referred to as a logic cage) designated by the dashed lines. As will be appreciated by those skilled in the gaming industry, the logic cage 201 includes a box-like mechanical structure that has slots to guide logic cards into the proper location for electronically plugging into a backplane mounted at the rear of the cage structure. The backplane has connectors for accepting mating connectors on the logic cards. The logic cage and associated cards form one of the basic components of the gaming machine 100 and is securely housed within the cabinet of the gaming machine 100.

Central to the logic cage is a central processing unit 202 such as a processor, a microcontroller-based platform, a suitable integrated circuit, or one or more application-specific integrated circuits (ASIC's). The processor 202 is in communication with or operable to access or to exchange signals with at an outcome evaluator 203, RAM 204, ROM 206, a non-volatile memory in the form of a compact flash 230, an audio output 208 via an audio control module 209, and a random number generator 210. The audio control module 209 has its own digital signal processor, analogue to digital converters, amplifiers and other circuitry necessary to broadcast the output from the speakers. RAM 204 may include non-volatile RAM (NVRAM), magnetic RAM (MRAM), ferroelectric RAM (FeRAM), and other forms as commonly understood in the gaming industry.

Compact flash memory 230 is physically secured within a slot in the logic cage 201. In one embodiment, the compact flash memory 230 is physically secured inside the logic cage within game logic circuitry 200 by a mechanical locking mechanism. Compact flash memory 230 is partitioned 231 into two parts. A first part comprises a game software module 232 and a second part comprises a metering information module 234.

The processor 202 runs executable code residing in game software module 232 of compact flash 230 that facilitates play of the game by a player through the display device and/or push buttons and touch sensors mounted in the screen of the display. Metering information module 234 contains the gaming machine parameters which include values that would usually be stored on a hard meter. The values in metering information module 234 are only ever incremented, and cannot be reset or decremented. The only way to alter the values stored is by running the executable code stored in game software module 232, which is executed by processor 202. The executable code further interacts with the credit dispenser 116 via a payout mechanism 224 and the auditory output 208. The game software module 232 contains the rules of the game, the sequence of gameplay, communicates with external systems, monitors peripheral equipment, maintain integrity of the software code, etc. The processor 202 continually checks for error conditions.

A program which implements the game logic circuitry 200 and the user interface is further run by the central processing unit 202. The processor 202 forms part of a controller 216 that drives the screen of the video display unit 104 and that receives input signals from sensors 218. The sensors 218 include sensors associated with the push buttons and touch sensors mounted in the screen of the video display unit 104. The controller 214 also receives input pulses from mechanisms 220 and 224 to determine whether or not a player has provided sufficient credit from either payment device 114 or payment device 116 to commence playing.

In one embodiment, a player may insert an identification card into a card reader (not shown) of the gaming machine 100. Such an identification card may be a smart card having a programmed microchip, a coded magnetic strip, or coded rewritable magnetic strip, wherein the programmed microchip or magnetic strips are coded with a player's identification, credit totals (or related data), and/or other relevant information. In another embodiment, a player may carry a portable device, such as a mobile phone, a radio frequency identification tag, or any other suitable wireless device, that communicates a player's identification, credit totals (or related data), and other relevant information to the gaming device.

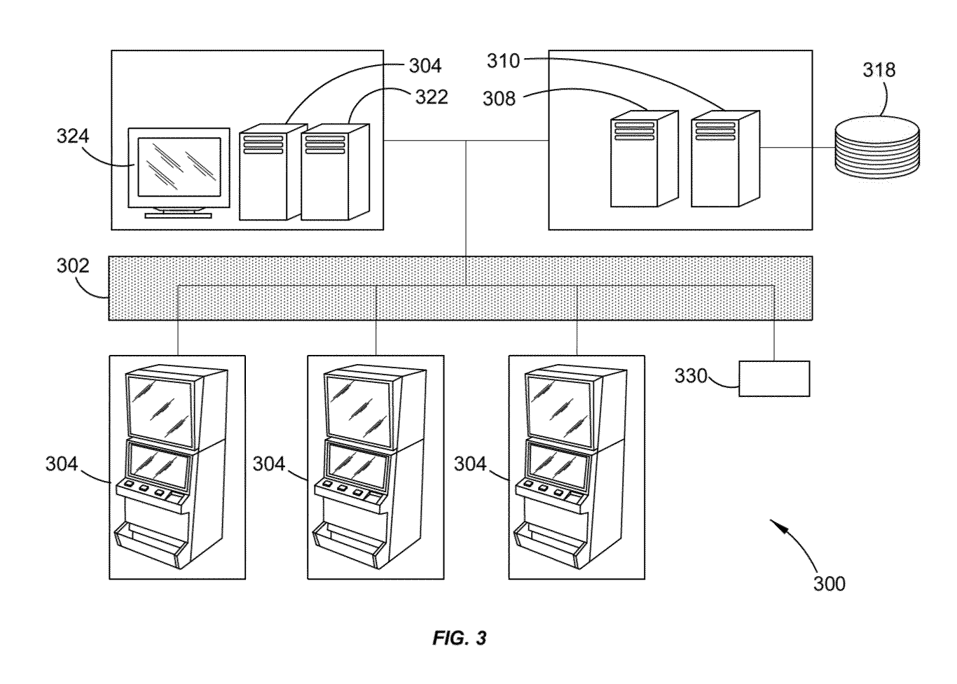

FIG. 3 shows a gaming system 300 in accordance with an alternative embodiment. The gaming system 300 includes a network 302, which for example may be an Ethernet network. The network 302 may also comprise a wide area network (“WAN”), the plain-old-telephone-system (“POTS), a local area network (“LAN”), a wireless LAN, the Internet, or any combination of these and other types of networks. Gaming machines 304 are connected to the network 302. The gaming machines 304 provide a player operable interface and may be the same as the gaming machines 100 shown in FIG. 1 or may have simplified functionality depending on the requirements for implementing game play.

In a thick client embodiment, game server 308 implements part of the game played by a player using a gaming machine 304 and the gaming machine 304 implements part of the game. With this embodiment, as both the game server 308 and the gaming device implement part of the game, they collectively provide a game controller. A database management server 310 may manage storage of game programs and associated data for downloading or access by the gaming devices 304 in a database 318.

In a thin client embodiment, game server 308 implements most or all of the game played by a player using a gaming machine 304 and the gaming machine 304 essentially provides only the player interface. With this embodiment, the game server 308 provides the game controller. The gaming machine will receive player instructions, pass these to the game server which will process them and return game play outcomes to the gaming machine for display. In a thin client embodiment, the gaming machines could be computer terminals, e.g. PCs running software that provides a player interface operable using standard computer input and output components.

Servers are also typically provided to assist in the administration of the gaming network 300, including for example a gaming floor management server 320, and a licensing server 322 to monitor the use of licenses relating to particular games. An administrator terminal 324 is provided to allow an administrator to run the network 302 and the devices connected to the network.

The gaming system 300 may communicate with other gaming systems, other local networks, for example a corporate network, and/or a wide area network such as the Internet, for example through a firewall 330.

Persons skilled in the art will appreciate that in accordance with known techniques, functionality at the server side of the network may be distributed over a plurality of different computers. For example, elements may be run as a single “engine” on one server or a separate server may be provided. For example, the game server 308 could run a random generator engine. Alternatively, a separate random number generator server could be provided. Further, persons skilled in the art will appreciate that a plurality of game servers could be provided to run different games or a single game server may run a plurality of different games as required by the terminals.

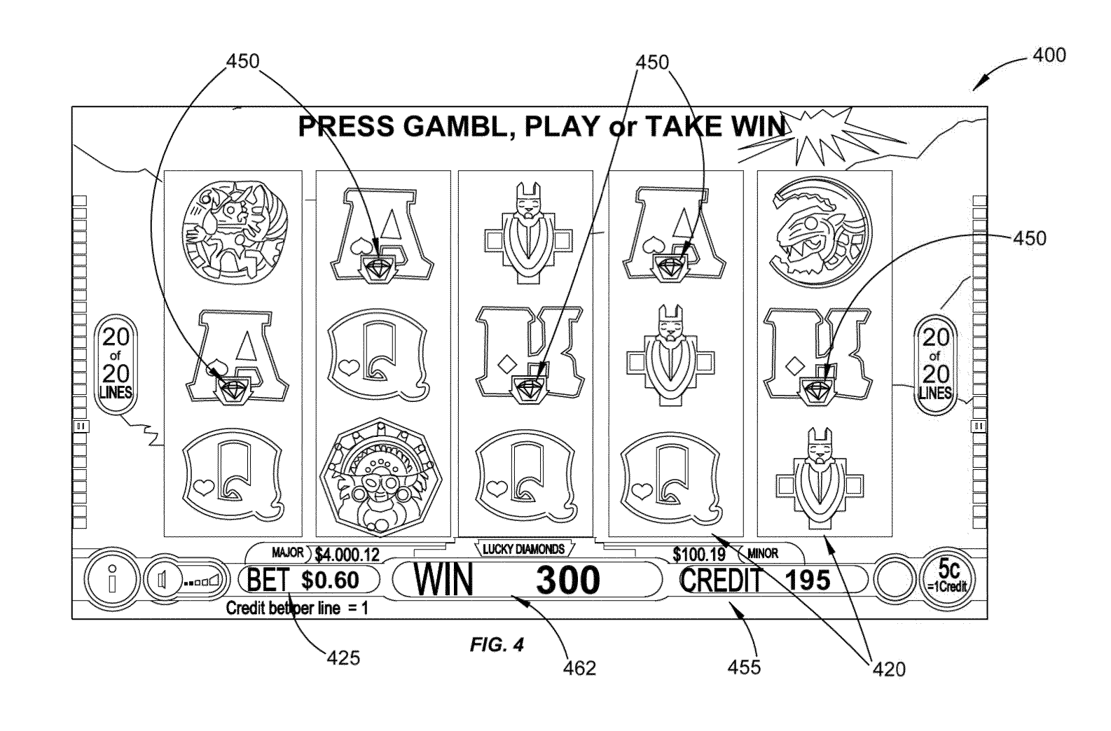

Referring now to FIGS. 4 to 6, features and functions of game machine 100 and gaming system 300 are described in further detail with respect to display images 400 500 and 600 generated by execution of code comprised in the game software module 232.

Before commencing play of the gaming machine 100, the player places a wager, and in this embodiment the player selects a number of play lines and a bet per line. For example, if the player selects twenty lines and five credits bet per line, the total wager is 100 credits. In another embodiment, and in relation to a game that uses reel patterns instead of lines, five reels at the cost of twenty-five credits and a “5×” bet multiplier would result in a total wager of 125 credits.

Referring now to FIG. 4 in which is depicted a video display 400 of a spinning reel game having five spinning reels carrying symbols. As is shown, the player's wager comprised twenty play lines and one credit bet per line. Each of the spinning reels (two of which are numbered 420) are depicted in a stopped position, such a position being determined according to a random selection process for revealing a 3×5 matrix of said symbols. Also displayed on the video display 400 and visible to the player are a “bet” meter 425 which shows the last wager made by the player, a “win” meter 426 which shows the total amount of winnings from the last completed and a credit meter 455.

Stored to memory (Ram 204 or Rom 206) is data concerning a predetermined number of bonus symbols, a predetermined number of gaming symbols, and an association between each bonus symbol and a particular type of a plurality of symbols. In this embodiment the bonus symbol is a diamond symbol 450 and all Kings and Ace, being types of symbols, are associated with the diamond symbol 450. Since the number of gaming symbols and bonus symbols is fixed, the probability of spinning up a diamond symbol is constant. Further stored to memory is data concerning a set of bonus features which include, but are not limited to bonus awards such as bonus credits, one or more multipliers, and jackpot awards.

The displayed symbols in the stopped position are evaluated by the gaming controller 201 to determine whether they include the requisite configuration of bonus symbols 450 to initiate a trigger event. In this embodiment to initiate the trigger event, a bonus symbol 450 needs to be present on each reel 420 and the configuration of the bonus symbols formed needs to align with a play line. In this illustrated embodiment, the configuration of the bonus symbol formed aligns with a play line and therefore the gaming circuitry 200 initiates the trigger event. At this stage in the process, the bonus event linked to each bonus symbol is undetermined. In other embodiments, the foreground bonus symbol must follow the same pattern as the underling game symbol. For example if five “King” symbols in a particular configuration would result in a predefined winning event occurring, then five bonus symbols in the same configuration will initiate the trigger event.

In order to maintain that the return to player percentage is at least equal to a predetermined return to player, the gaming controller 201 then allocates a bonus feature with each of the five bonus symbols. Hence, the number of jackpot awards is proportional to the money bet. In this embodiment the bonus feature can be a bonus prize or a special Jackpot symbol, which after awarding the gaming machine returns back to the primary game of chance. The Jackpot symbol is the Wheel, as disclosed in Australian provisional application 2013901437 titled ‘Game machine and method for presenting payouts' filed on 24 Apr. 2013, the contents of which are herein incorporated by reference. In other embodiments the special Jackpot symbol awards a jackpot prize straight away.

The ratio of the allocated bonus prizes to jackpot symbols is dependent on the input player wager, and specification on the size of the bet per line. As is the case in illustration, since the player has wagered one credit per line, one of the diamond bonus symbols will be linked to a wheel (the special jackpot symbol) and the remaining four diamond bonus symbols will be linked respectively to a bonus prize. In a different embodiment, if the player wagered three credits per line, then there will be three wheels linked to a respective diamond bonus symbol and two bonus prizes linked respective to one of the remaining bonus symbols.

At this stage, the bonus features associated with each of the diamond symbols remain hidden to the player.

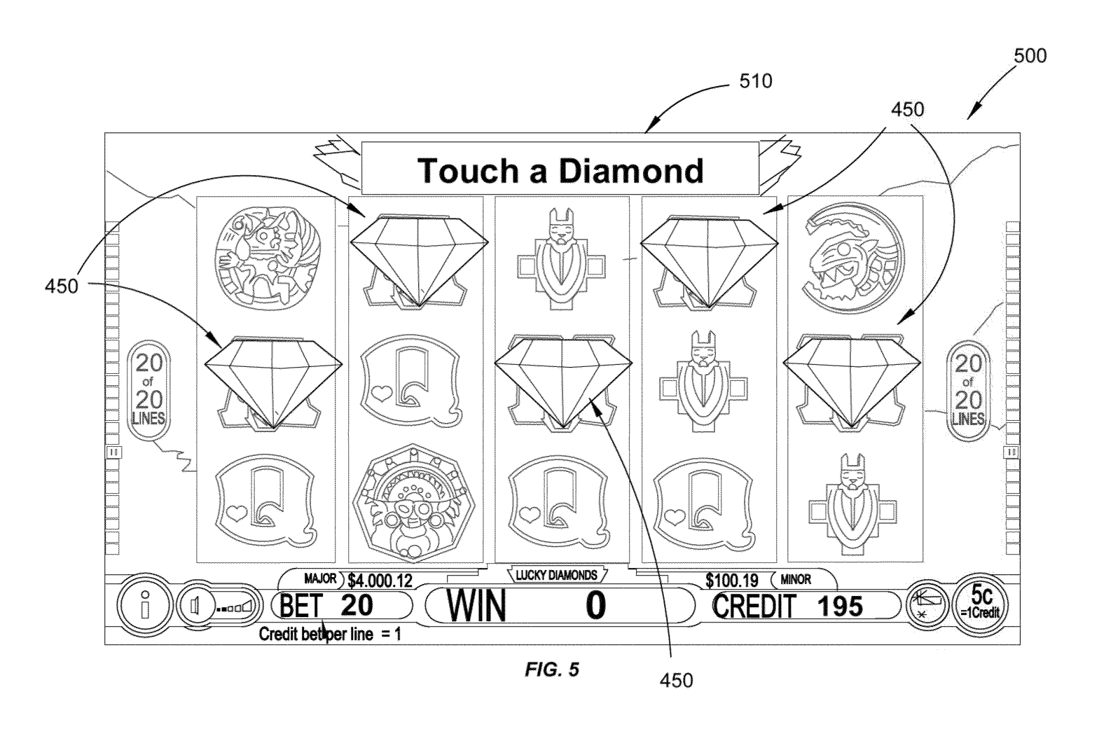

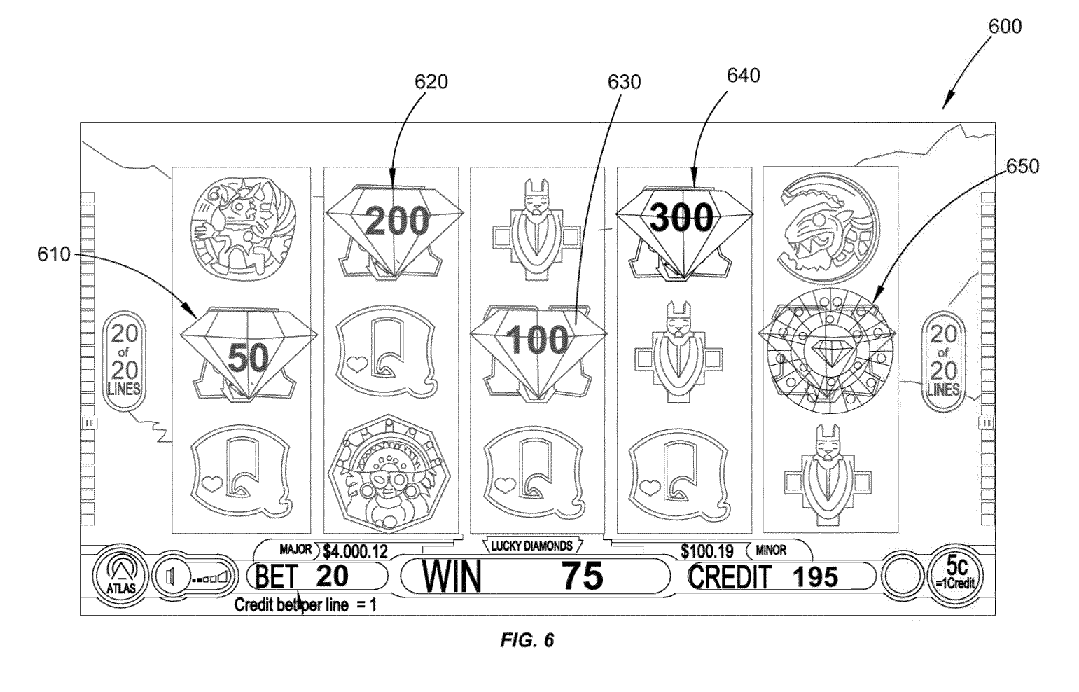

Referring now to FIG. 5, a video display 500 of the stopped spinning reels from FIG. 4 is shown, whereby each of the bonus symbols 450 are visually enhanced. To access a bonus feature the player is prompted 510 to select one of the bonus symbols. Having selected one of the bonus symbols, video display 600 of FIG. 6 displays the revealed bonus features (610, 620, 630, 640 and 650), each of which are associated with one of the bonus symbols shown in FIG. 5. The player's selection of bonus symbol 640 is visually enhanced. As is shown, the player's selection 640 returned a bonus award of 300 credits. Had the player selected bonus symbol 650, the gaming controller would have returned a jackpot award.

In the embodiments described, the type of symbol, Ace, King, Jack etc to which a bonus symbol is applied remains constant and does not fluctuate during play of a primary game. This preserves the integrity of the gaming machine, and provides the player with a degree of certainty in that the player can assess the degree of likelihood that a bonus feature will be awarded.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

While the foregoing description has been provided by way of example of the preferred embodiments of the present invention as presently contemplated, which utilise gaming machines of the type found in casinos, those skilled in the relevant arts will appreciate that embodiments of the present invention also may have application to internet gaming and/or have application to gaming over a telecommunications network, where mobile handsets are used to display game outcomes and receive player inputs. Such mobile devices include smart phones, notebooks, tablets, iPads and laptop computers. For instance free mobile device games may be offered for download and play on a players personal mobile device as a bonus game play. In such an embodiment the gaming machine may comprise a power interface to enable interaction between the respective devices and/or a communication or wireless interface to enable data transfer. During game play, the gaming machine may be configured to send information to the player's personal mobile device.

Further embodiments may enable a player to upload the outcome of a game or bonus game to a social media site(s), post tournament scores etc.

Certain steps in the processes or process flows described in this disclosure naturally precede others for the invention to function as described. However, the invention is not limited to the order of the steps described if such order or sequence does not alter the functionality of the invention. That is, it is recognized that some steps may performed before, after, or parallel (substantially simultaneously with) other steps without departing from the scope and spirit of the invention. In some instances, certain steps may be omitted or not performed without departing from the invention. Further, words such as “thereafter”, “then”, “next”, etc. are not intended to limit the order of the steps. These words are simply used to guide the reader through the description of the exemplary method.

Additionally, one of ordinary skill in programming is able to write computer code or identify appropriate hardware and/or circuits to implement the disclosed invention without difficulty based on the flow charts and associated description in this specification, for example.

Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the figures which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another.

A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

Disk and disc, as used herein, includes compact disc (“CD”), laser disc, optical disc, digital versatile disc (“DVD”), floppy disk and blu-ray disc where disks usually reproduce data magnetically, while discs reproduce data optically with lasers. Combinations of the above should also be included within the scope of computer-readable media.

Although selected aspects have been illustrated and described in detail, it will be understood that various substitutions and alterations may be made therein without departing from the spirit and scope of the present invention.

1. A gaming machine comprising:
a display to display images;
a user interface to receive input in relation to a player wager;
a memory for storing data concerning a predetermined number of bonus symbols, a predetermined number of gaming symbols, and an association between each bonus symbol and at least one particular type of a plurality of gaming symbols; and
a game controller configured, in response to the player wager, to play a primary game of chance to reveal a plurality of said gaming symbols on the display means, the game controller further configured to:
visually depict the bonus symbol with its associated gaming symbol in the revealed plurality of said gaming symbols; and
determine if a configuration formed by the bonus symbols on the display screen is indicative of a trigger event, said trigger event inclusive of an opportunity to win a progressive jackpot;
wherein the predetermined number of bonus symbols and the predetermined number of gaming symbols remains constant irrespective of a change in the player wager.

2. A gaming machine according to claim 1, wherein the primary game of chance is a reel game comprising a plurality of reels and allocated to each reel are a predetermined number of bonus symbols and a predetermined number of gaming symbols.

3. A gaming machine according to claim 1, wherein the player wager associated with the primary game of chance comprises a number of play lines and a bet per play line.

4. A gaming machine according to claim 1, wherein the player wager associated with the primary game of chance comprises a number reel patterns per credit and a multiplier.

5. A gaming machine according to claim 1, wherein if the determination of the configuration formed from the bonus symbols is indicative of a trigger event, the game controller is further configured to link each bonus symbol to a bonus feature selected from a set of bonus features.

6. A gaming machine according to claim 5, wherein the set of bonus features includes at least one of: bonus prizes awards; random prize awards;applying award multipliers;bonus rounds of free games; progressive jackpot awards; and a second screen feature with an opportunity to win a progressive jackpot award.

7. A gaming machine according to claim 6, wherein the number of jackpot awards allocated to be linked to respective bonus symbols is proportional to the bet per play line.

8. A gaming machine according to claim 6, wherein the number of jackpot awards allocated to be linked to respective bonus symbols is proportional to the bet multiplier.

9. A gaming machine according to claim 1, wherein the game controller is further configured to superimpose each bonus symbol over the underlying symbol to which it is associated.

10. A gaming machine according to claim 9, wherein the bonus symbol is at least partially transparent so that the underlying symbol is visible beneath it.

11. A gaming machine according to claim 2, wherein the game controller is further configured to provide the spinning reel game so that each and every bonus symbol is configured to be simultaneously displayed as held with their associated underlying symbol while their respective spinning reels are spun in the play of the primary game.

12. A gaming machine according to claim 9, wherein the game controller is further configured to visually enhance the depiction of each of the bonus symbols.

13. A computer-readable medium storing machine-readable instructions to cause a processor of a gaming machine to:
store data concerning a predetermined number of bonus symbols, a predetermined number of gaming symbols, and an association between each bonus symbol and at least one particular type of a plurality of gaming symbols;
in response to the player wager, play a primary game of chance to reveal a plurality of said gaming symbols on the display means;
visually depict the bonus symbol with its associated gaming symbol in the revealed plurality of said gaming symbols; and
determine if a configuration formed by the bonus symbols on the display screen is indicative of a trigger event, said trigger event inclusive of an opportunity to win a progressive jackpot;
wherein the predetermined number of bonus symbols and the predetermined number of gaming symbols remains constant irrespective of a change in the player wager.

14. A computer-readable medium according to claim 13, wherein the primary game of chance is a reel game comprising a plurality of reels, the medium storing machine-readable instructions to cause the processor of the gaming machine to allocate to each reel a predetermined number of bonus symbols and a predetermined number of gaming symbols.

15. A computer-readable medium according to claim 13, storing machine-readable instructions to cause the processor of the gaming machine to determine if the configuration formed from the bonus symbols is indicative of a trigger event, and if the configuration is indicative of a bonus event, to link each bonus symbol to a bonus feature selected from a set of bonus features including at least one of bonus prizes, multipliers and jackpot awards and.

16. A computer-readable medium according to claim 15, storing machine-readable instructions to cause the processor of the gaming machine to receive a player selected bonus symbol and in response, to display the bonus feature to which the player selected bonus symbol is linked or display each bonus feature linked to each respective bonus symbol.

17. A computer-readable medium according to claim 16, storing machine-readable instructions to cause the processor of the gaming machine to upon a player selection, display the bonus feature associated with each bonus symbol.

18. A computer-readable medium according to claim 13, storing machine-readable instructions to cause a processor of a gaming machineto superimpose each bonus symbol over the underlying symbol to which it is associated; wherein the bonus symbol is at least partially transparent so that the underlying symbol is visible beneath it.

19. A computer-readable medium according to claim 14, storing machine-readable instructions to cause a processor of a gaming machineto provide the spinning reel game so that each and every bonus symbol is configured to be simultaneously displayed as held with their associated underlying symbol while their respective spinning reels are spun in the play of the primary game.

20. A computer-readable medium according to claim 18, storing machine-readable instructions to cause a processor of a gaming machineto visually enhance the depiction of each of the bonus symbols.

21. A gaming system comprising at least one server and at least one client device, wherein the at least one server and at least one client device are configured to cooperate with each other to execute program instructions to:
store data concerning a predetermined number of bonus symbols, a predetermined number of gaming symbols, and an association between each bonus symbol and at least one particular type of a plurality of gaming symbols;
in response to the player wager, play a primary game of chance to reveal a plurality of said gaming symbols on the display means;
visually depict the bonus symbol with its associated gaming symbol in the revealed plurality of said gaming symbols; and
determine if a configuration formed by the bonus symbols on the display screen is indicative of a trigger event, said trigger event inclusive of an opportunity to win a progressive jackpot;
wherein the predetermined number of bonus symbols and the predetermined number of gaming symbols remains constant irrespective of a change in the player wager.
